(19) United States
(12) Patent Application Publication
(10) Pub. No.: US 2013/0332307 A1
(43) Pub. Date: Dec. 12, 2013

(54) METHOD FOR NOTIFYING A SENDER OF A GIFTING EVENT

(71) Applicant: Facebook, Inc., Menlo Park, CA (US)

(72) Inventors: Lee Linden, San Francisco, CA (US); Benjamin Lewis, San Francisco, CA (US)

(73) Assignee: FACEBOOK, INC., Menlo Park, CA (US)

(21) Appl. No.: 13/684,084

(22) Filed: Nov. 21, 2012

Related U.S. Application Data
(60) Provisional application No. 61/562,254, filed on Nov. 21, 2011.
(60) Provisional application No. 61/641,744, filed on May 2, 2012.

(51) Int. Cl. G06Q 30/06; G06Q 50/00

(52) U.S. Cl. CPC G06Q 30/0631; G06Q 50/01
USPC 705/26.7

(57) ABSTRACT

One variation of the method includes: within a set of communications from a set of users and directed to a recipient within a social networking system, identifying indicators of a gift-appropriate event of the recipient; selecting a gift for the recipient in response to a threshold number of communications with an identified indicator of the gift-appropriate event; selecting a sender, outside the set of users, based on a determined relationship between the sender and the recipient; transmitting an electronic notification to the sender, the electronic notification including an recommendation for the gift for the recipient; and modifying the recommendation in response to an update event following transmission of the electronic notification to the sender and prior to purchase of the gift, by the sender, for the recipient.

### CROSS-REFERENCE TO RELATED APPLICATIONS

This application claims the benefit of U.S. Provisional Application No. 61/562,254, filed on Nov. 21, 2011 and titled “Method for Generating Gift-Appropriate Event Notifications,” which is incorporated in its entirety herein by this reference.

This application further claims the benefit of U.S. Provisional Application No. 61/641,744, filed on May 2, 2012 and titled “Method for Selling a Product to a Sender,” which is incorporated in its entirety herein by this reference.

This application is related to: U.S. patent application Ser. No. 13/615,289, filed on Sep. 13, 2012 and titled “Method for Enabling a Gift Transaction”; U.S. patent application Ser. No. 12/978,265, filed on Dec. 23, 2010 and titled “Contextually Relevant Affinity Prediction in a Social Networking System”; U.S. patent application Ser. No. 13/239,340, filed on Sep. 21, 2011 and titled “Structured Objects and Actions on a Social Networking System”; U.S. patent application Ser. No. 12/508,521, filed on Jul. 23, 2009 and titled “Markup Language for Incorporating Social Networking Information by an External Website”; U.S. Pat. No. 8,250,145, issued on Aug. 21, 2012 and titled “Personalizing a Web Page Outside of a Social Networking System with Content from the Social Networking System”; U.S. patent application Ser. No. 12/969,368, filed on Dec. 15, 2010 and titled “Comment Plug-In for Third Party System”; and U.S. patent application Ser. No. 13/167,702, filed on Jun. 24, 2011 and titled “Suggesting Tags in Status Messages Based On Social Context”, all of which are incorporated in their entirety by this reference.

### TECHNICAL FIELD

This invention relates generally to the field of e-commerce, and more specifically to a new and useful method for advertising a gift to a sender in the field of e-commerce.

### BACKGROUND

People commonly use social networking systems to access and respond to certain life events of friends and family, such as birthdays, weddings, holidays, competitions, births, new jobs, etc. Sometimes, these life events are appropriate gifting events. However, many social networks fail to link gifting opportunities to such gifting events, and users interested in gifting must navigate to other gifting venues in order to select a gift for a friend or family member. This can lower overall gifting rates and/or siphon users away from a social networking system.

### BRIEF DESCRIPTION OF THE FIGURES

FIG. 1 is a flowchart representation of a method of one embodiment;

FIG. 2 is a flowchart representation of a variation of the method;

FIG. 3 is a flowchart representation of a variation of the method;

FIG. 4 is a graphical representation of a sender interface in accordance with a variation of the method;

FIG. 5 is a graphical representation of a sender interface in accordance with a variation of the method;

FIG. 6 is a graphical representation of a recipient interface in accordance with a variation of the method;

FIG. 7 is a block diagram of a system environment for a social networking system; and

FIG. 8 is a block diagram of a system architecture of the social networking system;

FIG. 9 is a flowchart representation of a variation of the method;

FIG. 10 is a flowchart representation of a variation of the method;

FIG. 11 is a flowchart representation of a variation of the method;

FIG. 12 is a flowchart representation of a Block in accordance with one variation of the method; and

FIG. 13 is a flowchart representation of a Block in accordance with one variation of the method.

### DESCRIPTION OF THE EMBODIMENTS

The following description of the embodiments of the invention is not intended to limit the invention to these embodiments, but rather to enable any person skilled in the art to make and use this invention.

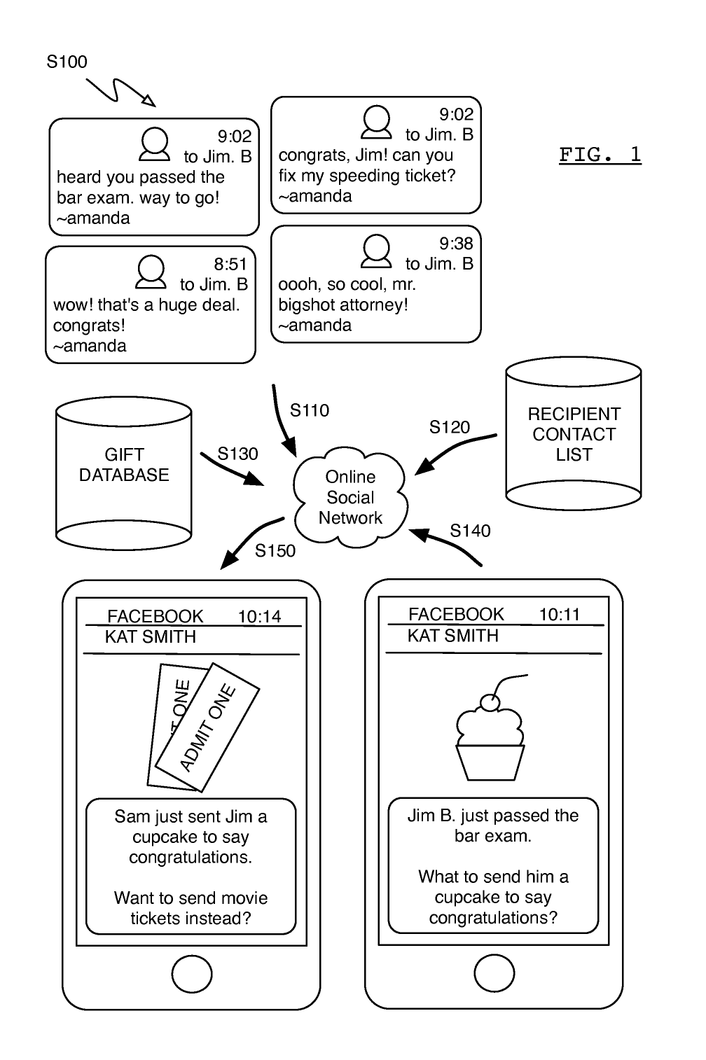

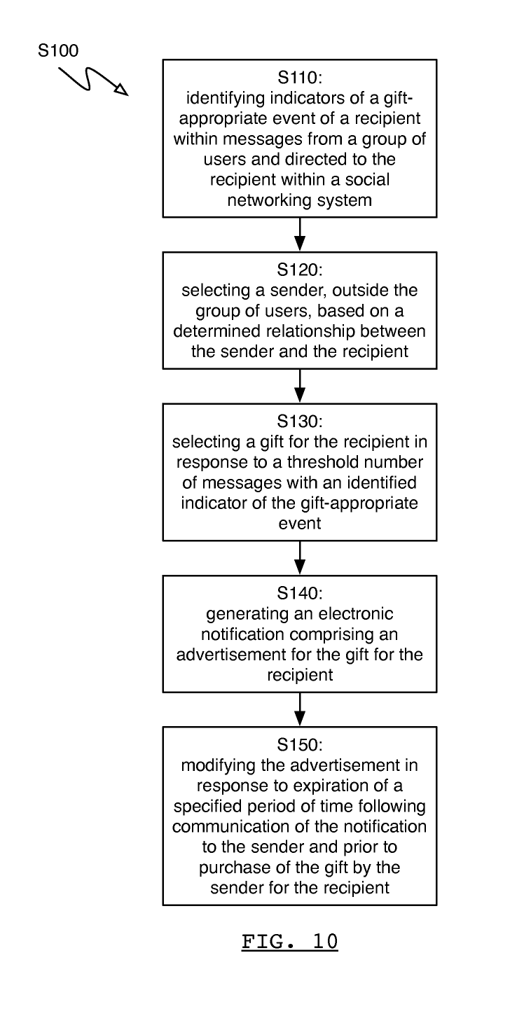

As shown in FIGS. 1 and 9, a method S100 for notifying a sender of a gifting event includes: within a set of communications from a set users and directed to a recipient within a social networking system, identifying indicators of a gift-appropriate event of the recipient in Block Silo; selecting a sender, outside the set of users, based on a determined relationship between the sender and the recipient in Block S120; selecting a gift for the recipient in response to a threshold number of communications with an identified indicator of the gift-appropriate event in Block S130; transmitting an electronic notification to the sender in Block S140, the electronic notification including a recommendation for the gift for the recipient; and modifying the recommendation in response to an update event following transmission of the electronic notification to the sender and prior to purchase of the gift, by the sender, for the recipient in Block S150.

As shown in FIGS. 9, 10, and 11, the method S100 functions to identify an instance in which a sender may have missed or is likely to miss a gift-appropriate event of a recipient, to notify the sender of the gift-appropriate event, and to suggest to the sender a gift that is appropriate for recipient in light of the event. The method S100 can enable this functionality by determining a gift-appropriate event of a recipient based on messages or other communications directed to the recipient within a social networking system, selecting a sender who has not yet responded to the gift-appropriate event, recommending a gift, for the recipient, to the sender in light of the gift-appropriate event, and updating the recommendation for the gift based on the occurrence of an update event prior to submission of an order for a gift by the sender. An update event can include one or more of a passage of time following an initial or previous recommendation, a submission of an order for the gift for the recipient by another user, according to other purchases made by other users on behalf of the recipient, or in light of any other suitable factor. The method S100 can notify the sender on the day of (e.g., during) the determined gift-appropriate event or substantially following the gift-appropriate event, such as the following day. Generally, by notifying a sender of a gifting event on or shortly after the event occurs, the method S100 can limit missed gifting opportunities for the sender. By incorporating a recommendation for a suitable gift within the notification, the method S100 can also limit barriers to gift conversion for the sender. Furthermore, by updating the notification, the method S100 can substantially ensure that a recommended gift remains relevant to the recipient and to the sender.

The method S100 can identify the gift-appropriate event through analysis of communications previously sent to the recipient by other users. Communications can include messages and can originate external the social networking system but can also be received, organized, and/or routed to a user within the social networking system. Alternatively, communications can be messages, etc., that originate from within the social networking system but that are transmitted outside the social networking system. Given various factors, such as sender-recipient relationship, sender or recipient demographic, sender or recipient interest, etc., the method S100 can then identify the event as a relevant opportunity for the sender to send a gift to the recipient. The method S100 can subsequently select a proposed gift, which can be any one or more of a physical or tangible product (e.g., an action figure or foodstuff), a digital product (e.g., an ‘app’), a service (e.g., a massage), a virtual product, a credit (e.g., Facebook credit, merchant credit) an experience (e.g., an overnight stay in Napa Valley), or any other product (e.g., good or service). A reference to the term “product” is not limited to physical goods but includes various types of goods and services, charity donations, gift cards, memberships of organizations, tickets to events, media including music, videos, movies, etc. Once the sender selects the gift (whether it be the recommended gift or not), the method S100 can provide and/or direct the sender to a venue through which to complete an order for the gift for the recipient, such as a webpage, native mobile application, or a virtual or physical store or retail location. The method S100 can therefore provide pinpoint, occasion-specific, sender-specific, and/or recipient-specific recommendations for a particular product and substantially seamlessly direct the user toward purchase of the product. Generally, the method S100 can generate the notification that defines a particular need for a product (e.g., the gift-appropriate event), contextualizes the need for the product (e.g., a need of the recipient, a social expectation), selects the product to be recommended (e.g., based on the event, a demographic of the recipient, and/or the user), and informs the sender without necessitating input from the sender.

The method S100 can be implemented by a computer system, such as a cloud-based computer (e.g., Amazon EC3), a mainframe computer system, a grid-computer system, or any other suitable computer system, as shown in FIGS. 1, 2, and 3. The computer system can support a messaging platform for communicating messages between users, the recipient, the sender, and/or other senders. For example, the computer system can support, distribute, and collect communications via a distributed network, such as over the Internet, wherein one or more processors throughout the distributed network implement one or more Blocks of the method S100. The computer system can also incorporate a sender-side interface and a recipient-side interface. The sender-side interface can incorporate a recommendation field that can be displayed, an input field in which the sender may draft a note to the recipient, a payment field, and/or a link to complete a gift order for the recipient, and the recipient may review the completed note, access a gift, and/or review a gift order through the recipient-side interface. Generally, the sender- and recipient-side interfaces can each be accessible through a web browser or through a native application executing on an electronic device, such as a laptop computer, a desktop computer, a tablet, a smartphone, a personal data assistant (PDA), a personal music player, etc. and can be either internal or external a messaging platform within the social networking system.

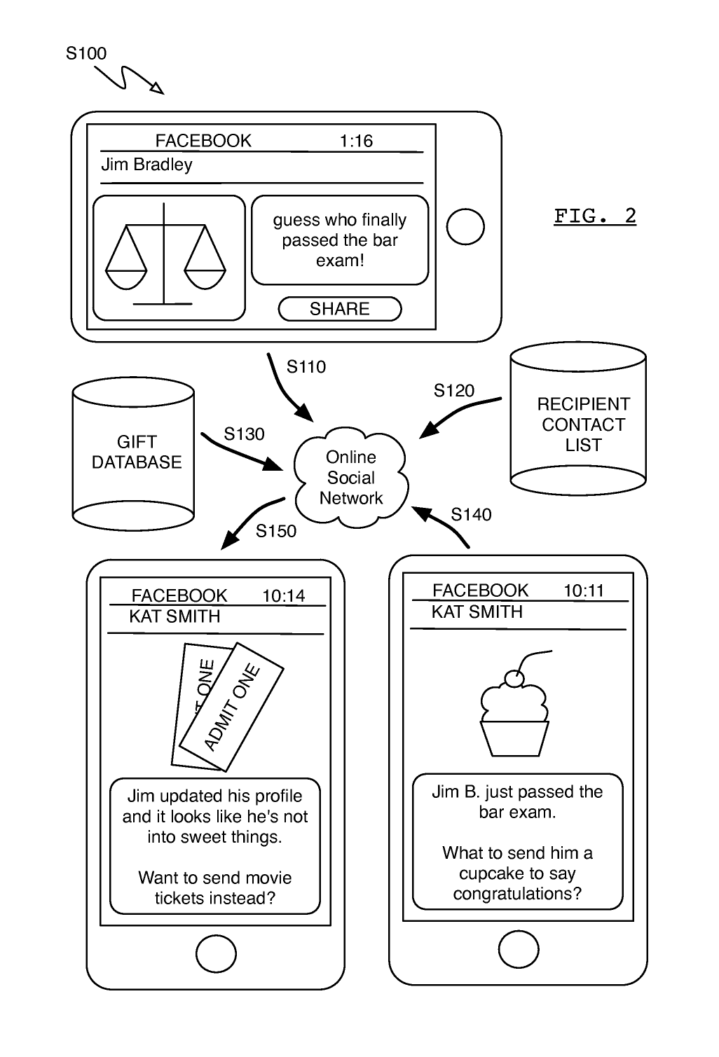

As shown in FIGS. 1 and 2, the method S100 can be implemented through a social networking system (e.g., Facebook) that enables communication between users, such as between potential senders and potential recipients. The social networking system can also contain relevant sender and/or recipient information (e.g., relationship statuses, demographic information, interests), track dates and/or occurrences of gift-appropriate events (e.g., birthdays, promotions, graduations, anniversaries), and/or track tangible and/or virtual gifts sent to the recipient by other users, all subject to the privacy settings of the user. Additionally or alternatively, the method S100 can be implemented by an online dating network, a single-merchant online marketplace, an online merchant aggregator, or any other suitable online or brick-and-mortar venue that enables remote exchange of products and/or services. Portions of method S100 can also be implemented by an external messaging platform, such as an instant messaging service (e.g., GoogleChat, AOL Instant Messenger), a mobile messaging service (e.g., SMS text message), or an electronic card service (e.g., egreetings.com). However, the method S100 can be implemented by any other computer system, service, or network and can include any other interface to support submission and retrieval of messages, notes, other communications, and data for senders and recipients, such as according to privacy settings set by the sender and by the recipient.

FIG. 7 is a block diagram of a system environment 100 for a social networking system 704. The system environment 100, shown in FIG. 7, includes a social networking system 704, a client device 708, a merchant system 712, a financial transaction service provider 114, and a network 740. Alternatively, the system environment 100 can include different and/or additional components than those shown in FIG. 7.

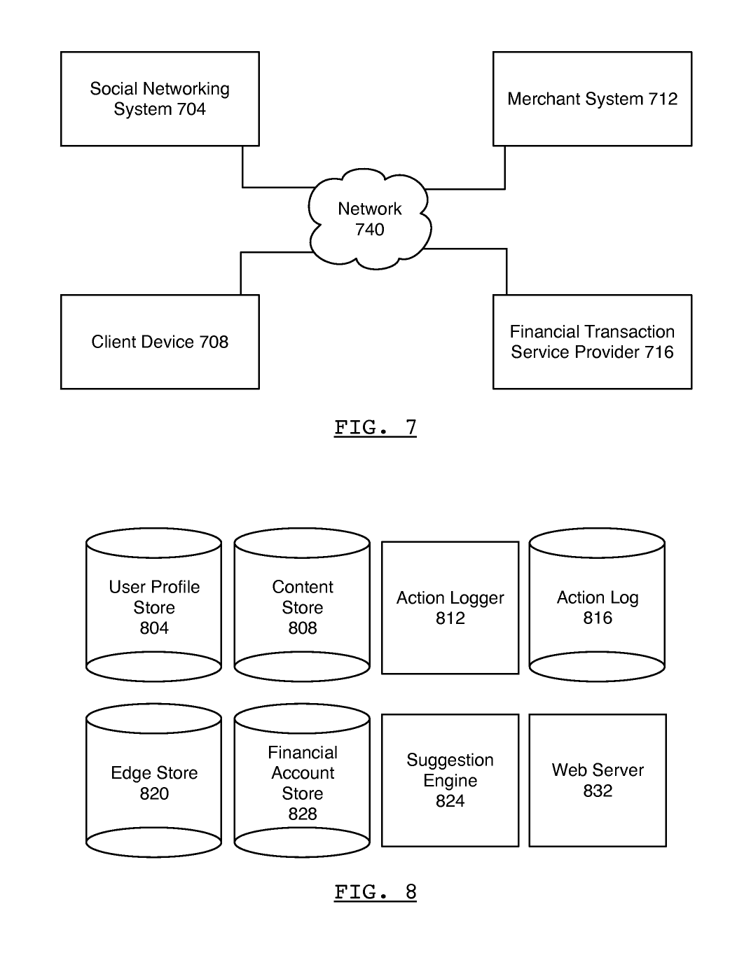

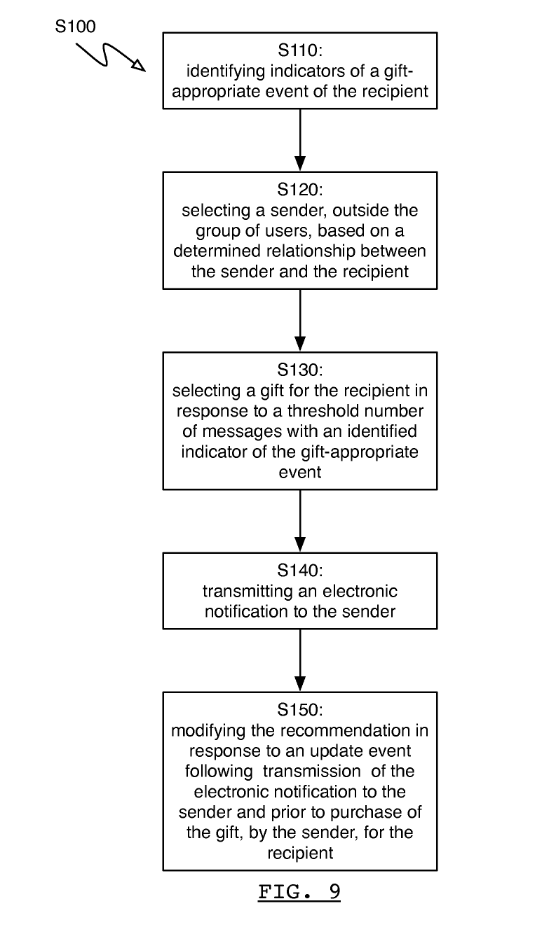

The social networking system 704, further described below in conjunction with FIG. 8, includes one or more computing devices storing user profiles associated with users and/or other objects as well as connections between users and other users and/or objects. In use, users join the social networking system 704 and then add connections to other users or objects of the social networking system to which they desire to be connected. As further described below in conjunction with FIG. 8, users of the social networking system 704 can be individuals or entities such as businesses, organizations, universities, manufacturers. The social networking system 704 allows its users to interact with each other as well as with other objects maintained by the social networking system 704. The social networking system 704 can therefore allow users to interact with third-party websites, such as the merchant system 712 and the financial transaction service provider 716. In one implementation, third-party developers can enable users of the social networking system to express interest in web pages hosted on websites external to the social networking system (e.g., third-party websites). These web pages can be represented as page objects in the social networking system as a result of embedding a widget, a social plug-in, programmable logic or code snippet into the web pages, such as an iFrame. Any concept that can be embodied in a web page can become a node in the social graph on the social networking system in this manner. As a result, users can interact with many objects external to the social networking system. Each of the interactions with an object can be recorded by the social networking system as an edge. These interactions can be used, for example, to identify a gift-appropriate event of the recipient. Enabling third-party developers to define object types and action types is further described in a related application, “Structured Objects and Actions on a Social Networking System,” U.S. application Ser. No. 13/239,340 filed on Sep. 21, 2011, which is hereby incorporated by reference. In one embodiment, the interaction can be a comment associated with a content object hosted by a third party system, as further described in a related application, “Comment Plug-In for Third Party System,” U.S. application Ser. No. 12/969,368 filed on Dec. 15, 2010.

Based on stored data about users, objects and connections between users and/or objects, the social networking system 704 generates and maintains a “social graph” comprising a plurality of nodes interconnected by a plurality of edges. Each node in the social graph represents an object or user that can act on another node and/or that can be acted on by another node. An edge between two nodes in the social graph represents a particular kind of connection between the two nodes, which can result from an action that was performed by one of the nodes on the other node. For example, when a user identifies an additional user as a friend or confirms a friend request from another user, the method can generate an edge in the social graph generated connecting a node representing the first user and an additional node representing the additional user. The generated edge has a connection type indicating that the users are friends. As various nodes interact with each other, the social networking system 704 modifies edges connecting the various nodes to reflect the interactions.

A client device 708 is a computing device capable of receiving user input as well as transmitting and/or receiving data via the network 740. In one implementation, the client device 708 is a conventional computer system, such as a desktop or laptop computer. In another implementation, the client device 708 can be a device having computer functionality, such as a personal digital assistant (PDA), mobile telephone, smart-phone or similar device. The client device 708 is configured to communicate with the social networking system 704, the merchant system 712 and/or the financial transaction service provider 716 via the network 740. In one implementation, the client device 708 executes an application allowing a user of the client device 708 to interact with the social networking system 704. For example, the client device 708 executes a browser application to enable interaction between the client device 708 and the social networking system 704 via the network 740. In another implementation, a client device 708 interacts with the social networking system 704 through an application programming interface (API) that runs on the native operating system of the client device 708, such as iOS® or ANDROID™.

The client devices 708 are configured to communicate via the network 740, which can include any combination of local area and/or wide area networks, using both wired and wireless communication systems. In one implementation, the network 740 uses standard communications technologies and/or protocols. Thus, the network 740 can include links using technologies such as Ethernet, 802.11, worldwide interoperability for microwave access (WiMAX), 3G, 4G, CDMA, digital subscriber line (DSL), etc. Similarly, the networking protocols used on the network 740 can include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 740 can be represented using technologies and/or formats including hypertext markup language (HTML) or extensible markup language (XML). In addition, all or some of the links can be encrypted using conventional encryption technologies such as secure sockets layer (SSL), transport layer security (TLS), and Internet Protocol security (IPsec).

The merchant system 712 includes one or more servers providing content associated with a merchant. For example, the merchant system 712 provides web pages describing products and/or services sold by one or more vendors. The merchant system 712 can also perform other functions to allow the merchant to provide products or services in exchange for compensation. Examples of functions provided by the merchant system 712 include maintaining accounts for purchasers, tracking inventory levels, modifying pricing of products or services, obtaining compensation for products or services from the financial transaction service provider 716 and/or other suitable actions. The merchant system 712 communicates with the social networking system 704, and/or the financial transaction service provider 716 via the network 740.

The financial transaction service provider 716 processes virtual currency transactions between a merchant and a customer, such as credit, debit, private-label, gift, payroll, a prepaid card, and/or other virtual currency, credit, or debit transaction. The financial transaction service provider 716 therefore directs a fund from a financial account of a consumer to a financial account of a merchant in response to a consumer purchase and can further direct a fund from a merchant to a consumer, such as in response to a return or exchange. The financial transaction service provider 716 can further provide fraud protection and authentication solutions, electronic check acceptance services, and/or Internet commerce and mobile payment solutions.

FIG. 8 is a block diagram of a system architecture of the social networking system 704. The social networking system 704 shown in FIG. 8 includes a user profile store 804, a content store 808, an edge store 820, an action logger 214, an action log 832, a suggestion engine 824, a financial account store 828 and a web server 232. Alternatively, the social networking system 704 can include additional, fewer, or different modules for various applications. Conventional components such as network interfaces, security mechanisms, load balancers, failover servers, management and network operations consoles, and the like are not shown so as to not obscure the details of the system architecture.

Each user of the social networking system 704 is associated with a user profile, which is stored in the user profile store 804. A user profile includes declarative information about the user that was explicitly shared by the user, and can also include profile information inferred by the social networking system 704. In one implementation, a user profile includes multiple data fields, each data field describing one or more attributes of the corresponding user of the social networking system 704. The user profile information stored in user profile store 804 describes the users of the social networking system 704, including biographic, demographic, and other types of descriptive information, such as work experience, educational history, gender, hobbies or preferences, location and the like. A user profile can also store other information provided by the user, for example, images or videos. Images of users can be tagged with identification information of users of the social networking system 704 displayed in an image. A user profile in the user profile store 804 can also maintain references to actions by the corresponding user performed on content items in the content store 808 and stored in the edge store 820.

A user profile can be associated with one or more financial accounts, which enables tracking of prepaid gifts and redemption of those gifts when using an associated financial account. A user can specify one or more privacy settings, which can be stored in the user profile. The privacy settings can specify the content and quantity of (personal) user data that can be tracked, shared, and/or accessed by the social networking system 704. In one implementation, information from the financial account is stored in the user profile store 804. Alternatively, information can be stored in the financial account store 828.

The content store 808 stores content items associated with a user profile, such as images, videos or audio files. Content items from the content store 808 can be displayed when a user profile is viewed or when other content associated with the user profile is viewed. For example, displayed content items can show images or video associated with a user profile or show text describing a user's status. Additionally, other content items can facilitate user engagement by encouraging a user to expand his connections to other users, to invite new users to the system or to increase interaction with the social network system by displaying content related to users, objects, activities, or functionalities of the social networking system 704. Examples of social networking content items include suggested connections or suggestions to perform other actions, media provided to, or maintained by, the social networking system 704 (e.g., pictures or videos), status messages or links posted by users to the social networking system, events, groups, pages (e.g., representing an organization or commercial entity), and any other content provided by, or accessible via, the social networking system.

The content store 808 also includes one or more pages associated with entities having user profiles in the user profile store 804. An entity is a non-individual user of the social networking system 704, such as a business, a vendor, an organization or a university. A page includes content associated with an entity and instructions for presenting the content to a social networking system user. For example, a page identifies content associated with the entity's user profile as well as information describing how to present the content to users viewing the brand page. Merchants associated with merchant systems 712, further described above in conjunction with FIG. 7, can be associated with pages in the content store 808, allowing social networking system users to more easily interact with the merchant via the social networking system 704. A merchant identifier is associated with a vendor's page, allowing the social networking system 704 to identify the merchant and/or to retrieve additional information about the merchant from the user profile store 804, the action log 832 or from any other suitable source using the vendor identifier.

The action logger 812 receives communications about user actions on and/or off the social networking system 704, populating the action log 832 with information about user actions. Such actions can include, for example, adding a connection to another user, sending a message to another user, uploading an image, reading a message from another user, viewing content associated with another user, attending an event posted by another user, among others. Moreover, the actions can relate to a merchant. In one example, a user can “like” an object associated with the merchant, for example, by explicitly making that indication on the merchant's page in the social network. In another example, a user can comment on a merchant's page within the social network, share a story from the merchant's page, tag a photo associated with the merchant or a product or service provided by the merchant, become a fan of the merchant, check-in to a brick-and-mortar store of the merchant, or subscribe or follow the merchant. As described in U.S. patent application Ser. No. 13/239,340, which is incorporated herein by reference, the edge store 820 can correlate any one or more such user actions with an interest in the merchant or a product of service from the merchant, which can be useful in selection an appropriate gift for the user who is a recipient.

The action log 832 can be used by the social networking system 704 to track user actions on the social networking system 704, as well as external website that communicate information to the social networking system 704. Users can interact with various objects on the social networking system 704, including commenting on posts, sharing links, and checking-in to physical locations via a mobile device, accessing content items in a sequence or other interactions. Information describing these actions can be stored in the action log 832, and the extent and content of such interactions can be correlated with an affinity for the objects. Additional examples of interactions with objects on the social networking system 704 included in the action log 832 include commenting on a photo album, communications between users, becoming a fan of a musician, adding an event to a calendar, joining a group, becoming a fan of a brand page, creating an event, authorizing an application, using an application and engaging in a transaction. Additionally, the action log 832 records a user's interactions with advertisements on the social networking system 704 as well as other applications operating on the social networking system 704. Data from the action log 832 is used to infer interests or preferences of the user, augmenting the interests included in the user profile and allowing a more complete understanding of user preferences.

The action log 832 can also store user actions on external websites and/or determined from a financial account associated with the user. For example, an e-commerce website that primarily sells sporting equipment at bargain prices can recognize a user of a social networking system 704 through social plug-ins that enable the e-commerce website to identify the user of the social networking system 704. Because users of the social networking system 704 are uniquely identifiable, e-commerce websites, such as this sporting equipment retailer, can use the information about these users as they visit their websites. The action log 832 records data about these users, including webpage viewing histories, advertisements that were engaged, purchases made, and other patterns from shopping and buying, such as in accordance with privacy settings of the user. Actions identified by the action logger 812 from the transaction history of a financial account associated with the user allow the action log 832 to record further information about additional types of user actions.

In one embodiment, an edge store 820 stores information describing connections between users and other objects on the social networking system 704 as edge objects. Some edges can be defined by users, allowing users to specify their relationships with other users. For example, users can generate edges with other users that parallel the users' real-life relationships, such as friends, co-workers, partners, etc. Other edges are generated when users interact with objects in the social networking system 704, such as expressing interest in a page on the social networking system, sharing a link with other users of the social networking system, and commenting on posts made by other users of the social networking system. The edge store 820 stores edge objects that include information about the edge, such as affinity scores for objects, interests, and other users. For example, an affinity score between a user and a merchant can be stored. Affinity scores can be computed by the social networking system 704 over time to approximate a user's affinity for an object, interest, and other users in the social networking system 704 based on the actions performed by the user. Multiple interactions between a user and a specific object can be stored in one edge object in the edge store 820, in one embodiment. Connections between users can be stored in the user profile store 804, or the user profile store 804 can access the edge store 820 to determine connections between users.

In one implementation, the financial account store 828 includes financial account identifiers associated with user profiles and an association or mapping between a financial account and its corresponding user profile. A user can include additional information about the financial account in the financial account store, such as a description of the financial account and can also include authentication information for accessing the account such as names, passwords or other security credentials. In implementation in which information about user financial accounts are stored in the financial account store 828, the social networking system 704 can apply additional security measures (encryption, etc.) to the financial account store 828 to reduce the risk of unauthorized access to financial account information. Alternatively, financial account information can be included in the user profile store 804 as data in a user's user profile. One or more privacy settings can be applied to the financial account information to limit its accessibility to objects in the social networking system 704.

The suggestion engine 824 accesses data in the user profile store 804, user profile store 804, in the action log 832, and/or the content store 808 either individually or in combination and identifies one or more candidate products associated with vendors in which a user is likely to have an interest. Generally, the suggestion engine can analyze the action log 832, identify user actions related to one or more merchants, products, or services, calculate the user's affinity for one or more merchants, products, or services, and select a suitable gift for the user based on the user's affinity. The suggestion engine 824 can also collect offers for products from local merchants, wherein the products can be collected or fulfilled through a physical retail location and/or through e-commerce. The suggestion engine 824 can further calculate an affinity between a user who is a (potential) recipient and a second user who is a (potential) sender, such as based on interactions between the users including messages, posts, and/or other communications between the users within the social networking system, and select the second user as the sender based on the affinity between the users. The suggestion engine 824 can subsequently recommend the selected gift to the sender and facilitate sender purchase of the product for the recipient.

Actions between the user and pages maintained by the social networking system stored in the action log 832 can be used by the suggestion engine 824 to select candidate products. The suggestion engine 824 can analyze actions involving the user and various pages in the content store 808 as well as connections between the user and various pages in the edge store 820 to select candidate products. For example, the suggestion engine 824 selects candidate products based on the frequency of actions between the user and a page, the number of interactions between the user and the page, the type of connection between the user and a page, staleness of the interactions, a type of action between the user and a page or any other suitable criteria.

The financial account store 828 can store a financial account identifier of one or more user IDs or profiles within the social networking system. The financial account store 828 can cooperate with the financial transaction service provider to track gifts, gift values, gift description, gift contents, etc. for a particular merchant and control application of a gift to a recipient purchase based on an identified match between a gift and a recipient purchase at the particular merchant. For example, the financial account store 828 can analyze merchant transactions, match a user social network ID to the purchase, and select an available gift affiliated with the user and redeemable at the merchant. The financial account store 828 can then communicate this information to the financial transaction service provider to initiation deduction of the gift amount from the recipient's bill without exposing user (e.g., sender or recipient) identification information to the financial transaction service.

The web server 232 links the social networking system 704 via the network 740 to the client device 708, to the financial transaction service provider 716 and/or to the merchant system 712. The web server 232 serves web pages, as well as other web-related content, such as Java, Flash, XML and so forth. The web server 232 can provide the functionality of receiving and routing communications between the social networking system 704 and the client device 708, for example, instant messages, queued messages (e.g., email), text and SMS (short message service) messages, or messages sent using any other suitable messaging technique. A user can send a request to the web server 232 to upload information, for example, images or videos that are stored in the content store 808. Additionally, the web server 232 can provide application programming interface (API) functionality to send data directly to native client device operating systems, such as iOS®, ANDROID™, webOS® or RIM. The web server 232 also provides API functionality for exchanging data, such as financial account information, between the social networking system 704 and the financial transaction service provider 716.

Block S110 of the method S100 recites identifying indicators of a gift-appropriate event of the recipient within a set of communications from a set of users and directed to a recipient within a social networking system. As shown in FIGS. 1 and 9, Block S110 functions to collect communications sent to the recipient by a set of other users, to analyze the communications, and to identify a gift-appropriate event of the recipient. The set of users can include one or more users, and the set of communications can include one or more communications. Block S110 can collect private ‘store and forward’ messages sent from a user to the recipient (e.g., Facebook Messages), private real-time messages sent from a user to the recipient (e.g., Facebook Instant Messenger), or public messages sent from a user to the recipient (e.g., a Facebook wall or timeline post or comment). However, Block S110 can additionally or alternatively collect communications communicated between a user and the recipient from external the social networking system, such as emails, SMS text messages, tweets, retweets, comments, pins, phone calls, voicemail messages, electronic greeting cards, or any other suitable text-, image-, video-, or audio-based messaging. By collecting multiple communications, Block S110 can limit false positives of gift-appropriate events by collecting a pool of communications to substantiate identification of a gift-appropriate event.

In one implementation, Block S110 counts the frequency of communications delivered to the recipient on a particular date and compares this frequency with the frequency of communications delivered on other dates, such as preceding days or the same day of the previous year. In this implementation, Block S110 can associate a sharp increase in communication frequency on a particular date, relative communication frequency on previous dates, with a gift-appropriate event. For example, if a potential recipient typically receives, on average, between three and six communications each day, but on a particular day received thirty-two communications, Block S110 can conclude that the a gift-appropriate event occurred or is occurring on the particular day. Alternatively, Block S110 can handle a sharp increase in communication frequency on a particular date as a trigger for further analysis of communication content to confirm the gift-appropriate event of the recipient (as in the following implementation).

In another implementation, Block S110 implements natural language processing to extract words, phrases, or images indicative of the gift-appropriate event from the communications, subject to privacy settings. For example, Block S110 can associate multiple communications directed from users to recipients and including the words “graduation,” “birthday,” or “congratulations” with a graduation, a birthday, and a new job, respectively, such as by comparing phrases or keywords in the communications with template words or phrases associated with particular gift-appropriate events. In another example, Block S110 can implement object recognition to correlate communication content with a gift-appropriate event, such as by correlating a communication sent to the recipient and including an image of balloons with a birthday. Block S110 can similarly implement information extraction, text mining, text analytics, textual analysis, content analysis, semantic analysis, and/or any other analysis or machine learning technique to extract identifying and/or gift-related information from communications between users and the recipient. In one implementation, topics indicative of a gift-appropriate event can be inferred, for example, as described in U.S. patent application Ser. No. 13/167,702, field on Jun. 24, 2011, titled, “Suggesting Tags in Status Messages Based on Social Context.”

Block S110 can additionally or alternatively analyze non-textual communications between users and the recipient, such as voicemail messages or phone calls, to identify the gift-appropriate event. Block S110 can also amass gift event indicators across multiple communication platforms to identify the gift-appropriate event.

Block S110 can implement gift event indicators as triggers for recipient selection and gifting event identification, and the method S100 can further implement the gift event indicators as triggers for subsequent Blocks of the method S100. For example, Block S110 can identify a suitable recipient and associated gifting event once a suitable number (e.g., threshold) of triggers are extracted from communications directed to a user within the social networking system. Block S110 can also associate a gift event trigger with a predefined event category within set of predefined event categories, such as the list {birthday, graduation, new job, baby, wedding, win by favored sports team, completion of exam or test, promotion, death of family member or friend, loss of job, or new dog}. Given a suitable number of gift event triggers of the same type, Block S110 can thus identify the gift-appropriate event.

Block S110 can therefore apply a threshold number of communications delivered to the recipient and/or including a gift-appropriate event indicator to confirm the gift-appropriate event. For example, Block S110 can adhere to a set number of communications (e.g., five) sent to the recipient and including gift-indicative language to trigger identification of the gift-appropriate event. Block S110 can also implement a dynamic gift-appropriate event trigger threshold, such as based on a demographic, social network use or communication history, social network connections, or any other parameter related to the sender and/or to the recipient. For example, the threshold can be low (e.g., five) for a recipient between the ages of fifty and sixty and high (e.g., twenty) for a recipient between the ages of fourteen and eighteen. The threshold can also be higher for female recipients than for male recipients (e.g., if females tend to receive more communications, on average, than males), and the threshold can be higher for a recipient with woo connections than for recipients with only fifty connections.

When identifying a trigger of a gift-appropriate event, Block S110 can also account for the degree of connection between the sender and other users who have sent communications to the recipient. For example, Block S110 can associate greater weight to communications sent to the recipient by other users who are closely connected to the sender than to communications sent to the recipient by other users who are only distantly connected to the sender through the social networking system. Block S110 can also identify a degree of a relationship or connection between a potential sender and a potential recipient, such as by ranking a list of potential senders based on a determined strength of a relationship with the recipient. For example, Block S110 can rank immediate family members first, following by close friends, extended family, relatively close friends, coworkers, and, finally, acquaintances or distant friends. To determine the strength of a relationship between the recipient and a potential sender, Block S110 can assess a number of pictures uploaded to the social networking system and tagged as including both the recipient and potential sender, a number of communications communicated between the recipient and potential sender within a period of time over the social networking system, common likes and/or common check-ins between the recipient and potential sender, such as at similar times, or any other factor indicative of a relationship or connection between the recipient and potential sender.

Block S110 can also calculate, specify, and/or customize a particular threshold number of communications to trigger identification of the gift-appropriate event for the recipient, such as by accounting for a demographic, social network use or communication history, social network connection, or any other parameter related to the sender and/or to the recipient. Block S110 can therefore tailor the threshold number of communications to trigger gifting event identification for a particular sender, for a particular recipient, or for a particular sender connected to a particular recipient.

Block S110 can further specify a time period within which the threshold number of gifting triggers must be identified in order to positively determine the occurrence of a gift-appropriate event. For example, Block S110 can specify a threshold number of twenty communications to be received by the recipient within a twenty-four hour period to determine a gift-appropriate event within a suitable degree of confidence.

Additionally or alternatively, Block S110 can identify the gift-appropriate event of the recipient based on personal information entered, by the recipient, into the social networking system. In one implementation, Block S110 extracts a gifting event from changes made by the recipient to his social network profile. For example, Block S110 can identify the gift-appropriate event as a marriage based on a recipient-entered change in marital status from “engaged” to “married.” In another implementation, Block S110 correlates a gifting event with new information entered by the recipient into his social network profile. For example, Block S110 can apply any of the foregoing natural language processing techniques to identify a significant life milestone for the recipient based on a recipient-entered public update that reads “just got my results, and it looks like i passed the bar exam!” Block S110 can then correlate this life milestone with a gift-appropriate event. In yet another implementation, Block S110 correlates a gift-appropriate event based on a communication entered by the recipient and communicated through the social networking system, such as by applying natural language processing. For example, Block S110 can determine an upcoming graduation of the recipient based on a communication sent by the recipient (e.g., to a family member) that reads, “Graduation is this Sunday, and Commencement begins at 10 am. Try to get to the auditorium by 9:45 so you'll be guaranteed a seat.” However, Block S110 can apply any other suitable technique or method to extract gifting event indicators from a public or private message, note, update, profile change, or account change entered by the recipient.

Block S110 can also implement a confidence interval threshold by calculating a likelihood (or confidence interval) that user communications and/or recipient-entered data are indicative of a gift-appropriate event. Once this likelihood reaches and/or surpasses the confidence interval threshold, Block S110 can recognize that the gift-appropriate event likely occurred and thus move to Block S120.

Block S110 can further include analyzing a recipient's posts with the social networking system, analyzing other users' posts, analyzing a recipient's behavior within and outside of the social networking system, or collecting and/or analyzing any other user and/or recipient related information inside or outside of the social networking system. However, Block S110 can function in any other suitable way to identify indicators of a gift-appropriate event of the recipient within a set of communications.

Block S120 of the method S100 recites selecting a sender, outside the set of users, based on a determined relationship between the sender and the recipient. Generally, Block S120 functions to select the sender based on a lack of communication between the sender and the recipient, such as within the social networking system. In particular, by selecting the sender who has not communicated with the recipient on a date coinciding with the identified gift-appropriate event or within a suitable time period following the gift-appropriate event, Block S120 can enable the method S100 to advertise the event and an associated gift to the sender when the sender may otherwise not respond to the event at all.

Once Block S110 identifies the gifting event of the recipient, Block S120 can select the sender from a contact list, friend list, social circle, etc. of the recipient within the social networking system, such as shown in FIGS. 1, 2, and 3. For example, Block S110 can select the sender who is listed as a close friend or family member of the recipient within the social networking system. Alternatively, Block S120 can select the sender, and Block S110 can mine a social networking contact list of the sender for gifting event indicators and select, as the recipient, a particular contact of the sender given a threshold number of indicators or a suitable degree of confidence in the gifting event of the selected recipient, such as according to privacy settings set by the sender. However, Block S110 can select the recipient and/or Block S120 can select the sender from any other suitable contact list, such as from a list of Twitter followers, an aggregated contact list from sender or recipient profiles across multiple social networking systems, a ‘Favorites’ contact list on a cellular phone or cellular plan, or a desktop address book.

Block S120 can further estimate or determine the degree of a relationship between the sender and the recipient to determine if the selected sender is a suitable entity to send a gift to the recipient and/or if the recipient's event is an appropriate gifting event for the sender. Generally, Block S120 can determine a relationship status between the sender and the recipient based on relationship status data stored in the social networking system, such as by extracting sender-recipient relationship data from personal profiles of the sender and the recipient within the social networking system. Block S120 can therefore function to filter out inappropriate gifting events and thus limit gift advertisements only to events particularly relevant to a selected sender.

In one example, for an event that is a birthday of the recipient, Block S120 can determine that the event is an appropriate gifting event for a selected sender who is a family member of the recipient but not for a user who is a coworker of the recipient. In another example, for an event that is a wedding of the recipient, Block S120 can determine that the event is an appropriate gifting event for a selected sender who is a close friend of the recipient but not for a user who is merely a professional acquaintance of the recipient. In another example, Block S120 can determine a potential sender who has been a Facebook friend of the recipient for five years and who regularly communicates with the recipient via Facebook to be a relatively close friend of the sender, and Block S120 can thus identify the potential sender as an appropriate entity to gift the recipient on a birthday, holiday, wedding, new job, birth of a child, graduation, etc. of the recipient. In contrast, Block S120 can determine a user who has not interacted with the sender outside of following the sender on Twitter to be outside of a close friend circle of the recipient, and Block S120 can thus exclude the user from gift suggestions for the recipient. However, the relationship between the sender and the recipient can be defined, ascertained, and/or used to inform Blocks S110 and/or S120 in any other way.

Block S120 can similarly determine that the event is an appropriate gifting opportunity for a selected sender based on a correlation between the sender and other users who have sent gifts to the recipient in response to the event. Generally, in determining the appropriateness of the event, Block S120 can attach a greater weight to a gift sent to the recipient by one user, who is closely connected to the sender, than to a gift sent to the recipient by a user who is only remotely connected to the sender. For example, if only distant connections to the sender have sent gifts and/or communications to the recipient, Block S120 can determine that the event is not a substantially relevant gifting opportunity for the sender, while Block S120 can determine that the event might be a substantially relevant gifting opportunity for the sender given close sender contacts who have sent gifts and/or communications to the recipient. However, Blocks S110 and S120 can function in any other way to select the recipient and sender, respectively.

Block S130 of the method S100 recites selecting a gift for the recipient in response to a threshold number of communications with an identified indicator of the gift-appropriate event. Block S130 can select a gift that is a tangible or virtual product, a physical or virtual service, a real or virtual experience, or any other suitable type of product or gift. Block S130 can also select the gift that is an end-use product (e.g., a digital music album, hardback book) or a gift card. Block S130 can select the gift that is suitable for the sender in light of at least one of the type of event, the relationship between the sender and recipient, a gift previously sent to the recipient (e.g., by another user), and an interest, like, demographic, purchase history, return history, exchange history, or location of the sender and/or recipient. Based on any one or more of these factors, Block S130 can select a product or service that both meets gifting needs of the sender and is suitable as a gift from the sender to the recipient. For example, Block S130 can access personal and/or contact information of the sender and/or recipient to determine that the sender is a grandparent of the recipient and, based on this, select a higher-priced item than for a second user who is a friend of the recipient. In another example, Block S130 can access location and personal data of the recipient to determine that the recipient is a teenage girl living in Portland, Oreg. and, from this data select a gift that includes two movie tickets for a romantic comedy playing at a local theatre rather than an entry ticket and beer ticket at a NASCAR event at Atlanta Motor Speedway in Hampton, Ga. In yet another example, Block S130 can access personal information entered by the recipient to determine that the recipient is a vegetarian, and, based on this information, avoid gifts for the recipient that are gift cards for local steakhouses. In yet another example, Block S130 can retrieve purchase records of the recipient to determine that the recipient frequently shops at a particular store and, from these records, select a gift that is a credit at the particular store (e.g., rather than a credit at a store not frequented by the recipient).

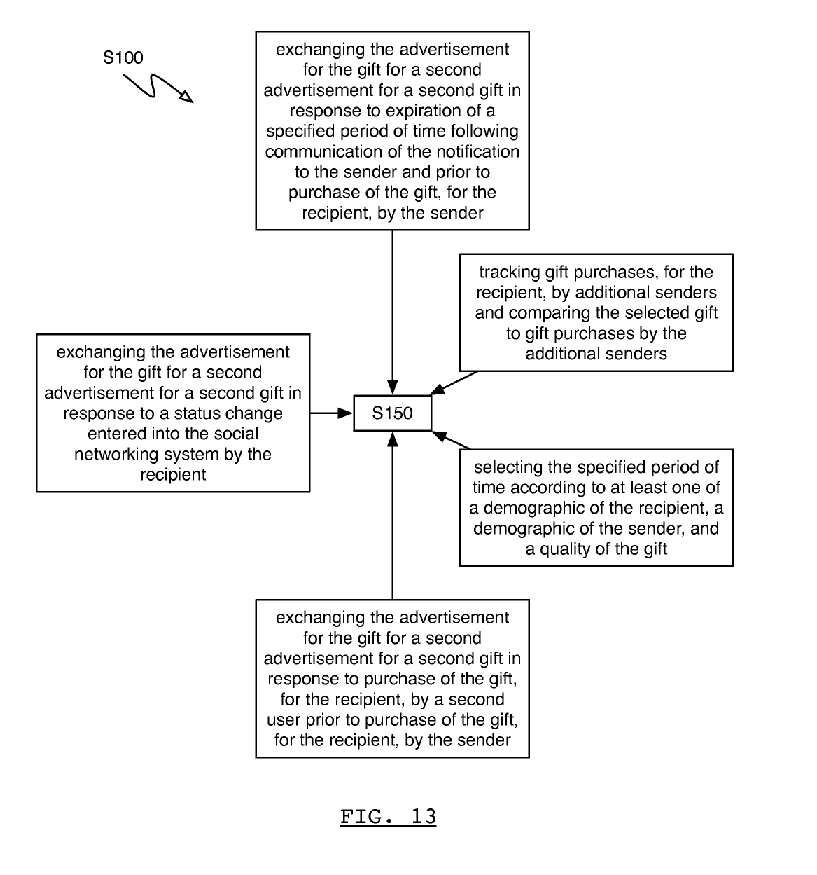

As shown in FIGS. 9 and 12, Block S130 can also select the product or merchant based on a determined recipient affinity for a particular product or merchant, such as described in U.S. patent application Ser. No. 12/978,265, which is incorporated in its entirety by this reference. For example, Block S130 can determine a recipient need, interest, and/or affinity based on a combination (e.g., weighted combination) of recipient interaction data within the social networking system and/or recipient purchase history. Furthermore, in identifying a particular product or merchant from a list of multiple products, services, or merchants, Block S130 can rank recommendations for products, services, or merchants based on a recipient affinity prediction model or a recipient social contact affinity prediction model, such as described in U.S. patent application Ser. No. 12/978,265. This model can also account for other gifts sent to the recipient by other users, such as duplicates and complementary products or services, when identifying recipient need to interest.

For example, the recipient can “like” a product or merchant by selecting a “Like” button on a website or from within the social networking system, such as through a web browser or within a native application, wherein Block S130 thus identifies the product or merchant as of interest to the recipient. In this example, by associating “likes” with a merchant, Block S130 can promote the value of “likes” for the merchant by converting a “like” to merchant revenue through gifting. In particular, Block S130 can associate a recipient “like” of the merchant with recipient interest in the merchant and subsequently select a gift offered by the merchant.

Block S130 can additionally or alternatively identify recipient interest based on a social graph, such as described in U.S. patent application Ser. No. 13/239,340, which is incorporated in its entirety by this reference. In this implementation, Block S130 can analyze a social graph incorporating data collected outside of the social networking system, such as Internet browsing history, downloaded content (e.g., music, e-books), viewed online content (e.g., videos), search history, etc. to extract recipient preferences, interests, needs, etc. However, Block S130 can identify a need or interest of the recipient and correlate the need or interest with a particular product, service, or merchant in any other way.

Block S130 can also interface with external hardware components and/or physical locations when selecting the gift. For example, Block S130 can access a current location of the recipient through a GPS module incorporated into a mobile computing device (e.g., digital multimedia device, smartphone, tablet) carried by the recipient and subsequently select the gift based on the recipient's proximity to a local merchant, such as an ice cream parlor within three blocks of the recipient's present location. In one implementation, Block S130 tracks a current location of the recipient such that Block S140 can prompt the sender to send the gift to the recipient when the recipient is at or suitably near an appropriate merchant or retailer. In one example, Block S120 monitors recipient check-ins and Block S140 prompts the sender to purchase the gift for the recipient when the recipient checks in to a retailer that offers the gift for sale. Block S130 can also track the location of the recipient through a GPS module incorporated in a smartphone carried by the recipient and similarly prompt the sender to purchase the gift for the recipient. Alternatively, Block S130 can track or access data pertaining to the recipient's location and/or monitor recipient check-ins identify a retailer within a specified distance from the recipient, and select the gift that is offered by the retailers. In this implementation, Block S130 can select the gift and Block S140 can prompt the sender to purchase the gift for the recipient substantially in real time such that the sender has the opportunity to send the gift to the recipient when the gift may be particularly relevant or useful for the recipient. Block S140 can also notify the recipient of the gift substantially in real time (e.g., substantially immediately following sender gift confirmation). For example, Block S130 can access a recipient check-in at Philz Coffee, access “like” data of the recipient, determine that the recipient likes Philz Coffee, and select a gift that is a $₅ gift card at Philz Coffee, Block S120 can select a daughter of the recipient as the sender, and Block S140 can prompt the daughter to purchase the $₅ gift card for her mother. Once the daughter orders the gift for her mother, the method S100 can substantially immediately notify the mother of the gift such that the mother can apply the gift to a purchase at Philz in the same visit.

Block S130 can also determine common interests between the sender and recipient based on past communications between the sender and the recipient. Block S130 can subsequently apply this common interest to select a gift that can be used by the sender and recipient together. In one example, Block S130 can determine that the sender and recipient have frequented water parks together in the past, such as based on a caption of an image of the sender and recipient at a water park, a sender and/or recipient check-in at a water park, or a message, referencing a water park, communicated between the sender and the recipient. In this example, Block S130 can subsequently select a gift that includes two entry tickets to a local water park such that the recipient may involve the sender in redemption of the gift.

Similarly, Block S130 can access personal data entered into the social networking system by the recipient to identify a partner, girlfriend, boyfriend, spouse, or other close companion of the recipient, such as according to recipient privacy settings. Block S130 can subsequently isolate common interests and/or actions of the recipient and his companion to select a gift suitable for both. For example, Block S130 can determine that the recipient and her boyfriend enjoy dinner at a particular restaurant and a movie on the first Friday of every month based on check-ins entered by her boyfriend and her purchase history. Based on this substantially regular action, Block S130 can select the gift that includes a bottle of wine at the particular restaurant.

Block S130 can select the gift further based on a purchase history of the sender. For example, Block S130 can determine, based on the sender's gifting history, that the sender is comfortable with a maximum gift price of approximately $₃₀ for family members, approximately $20 for his closest friends, and approximately $10 for other relatively close friends. Similarly, Block S130 can select the gift further based on a sender preferences entered into a gifting platform within the social networking system and/or into a gifting profile of the sender. For example, Block S130 can access gift price preferences entered into sender's gifting profile. Block S130 can similarly determine or access data pertaining to minimum spending preferences of the sender. Block S130 can thus avoid selecting a gift that is too expensive or too cheap for the sender based on determined or entered sender data. For example, for a recipient who enjoys drinking Scotch, Block S130 can select the gift that is a cheaper blended Scotch rather than a single-malt Islay Scotch in order to meet spending expectations and/or requirements of the sender.

Alternatively, in the foregoing example, Block S130 can select the more expensive single-malt Islay Scotch, which the recipient may be more likely to enjoy, and Block S140 can subsequently advertise the gift to the sender as a commitment to pay for a portion of the gift once a gifting tipping point is reached by other users who also commit to paying for a portion of the gift. Therefore, Block S130 can source funding for a particular gift from multiple senders. Generally, to support gifting of a gift that is more expensive than what any single sender is willing to purchase for the recipient, Block S130 can select the gift according to an anticipated payment scheme involving multiple senders, and the method S100 can initiate payment by the senders for the gift only once an adequate monetary value is committed by the senders to pay for the gift. The method S100 can thus enable gifting of an expensive gift to the recipient while still fulfilling gifting needs and/or expectations of the sender. Similarly, Block S130 can select a gift from gift sets, wherein subsequent notifications to subsequent senders include recommendations for a different item within the gift set. For example, Block S130 can select one book in a seven-volume set for each notification sent to one of seven of the recipient's friends.

Block S130 can select the gift from any suitable pool of available gift items. In one example implementation, Block S130 selects the gift from a limited pool of gift items offered by a merchant under specific contract with the social networking system. In another example implementation, Block S130 selects the gift item by interfacing with an online merchant aggregator (e.g., Amazon.com). In yet another implementation, Block S130 selects the gift item from a list of items “liked” by the recipient. Block S130 can also select the gift item from a list of items “pinned,” tweeted,” or otherwise mentioned in a communication by the sender, the recipient, and/or a contact of the sender or recipient within the social networking system. For example, Block S130 can select the gift that is a book “liked” by several close friends of the recipient, such as after determining that the recipient has not yet read the book based on textual analysis of a recent communication between the recipient and a friend that indicates the same. Block S130 can also select the gift item from a “wishlist” of the recipient, such as stored on an online merchant aggregator (e.g., Amazon.com), a window-shopping website (e.g., svpply.com), an online merchant (e.g., toryburch.com), or any other suitable online retail outlet. However, Block S130 can select the gift from any other suitable pool or list of available gift items.

Block S130 can define a particular product, set of products, or types of product with a particular predefined event category identified in the communications in Block S110. For example, a category that is ‘birthday’ can be tied to a product that is a cupcake, and a category that is ‘baby’ or ‘birth’ can be tied to a product that is baby socks. In the implementation in which Block S130 associated a group of products with a particular category, Block S130 can select particular product from the set based on additional factors, such as a demographic of the sender, a demographic of the recipient, or other gifts recently given to the recipient by other users. In one implementation, Block S130 defines subcategories within a predefined event category, wherein each subcategory defines a particular age group or a particular gender and includes at least one gift suitable for the associated demographic. For example, Block S130 can select a gift that is a subscription to Harper's BAZAAR for a female recipient who recently graduated from college (i.e., a female in the 21-25 age bracket) and can select a gift that is a G. I. Joe action figure for a male recipient who recently turned eight years old. However, Block S130 can associate any other suitable product or gift with any other suitable event category, and Block S130 can select any particular gift for the recipient based on any one or more factors.

Block S130 can further interface with a vendor to define a default or “go-to” product for a particular category or sub-category. The method S100 can charge the vendor a flat fee to set a particular product from that vendor as the default gift, or the method S100 can charge on a per-conversion basis. Block S130 can also define an ordered list of gifts for a particular event category, wherein each subsequent recommendation to a subsequent sender includes a recommendation for a subsequent gift within the ordered gift list. In this implementation, the method S100 can charge a vendor a flat fee based on where in the ordered set of gifts a particular gift of the vendor falls (e.g., a greater fee for an item nearer the top of the list). A fee per conversion for a particular product can also be related to the order of the particular product in the ordered gift set. However, the method S100 can charge fees or other rates for advertising and/or conversions according to any other schema.

As shown in FIGS. 2 and 12, Block S130 can also include monitoring gifts sent to the recipient by other users and thus exclude these previously-gifted items from a pool or list of items available to the sender as gifts for the recipient. Block S130 can therefore avoid selecting a gift that is a duplicate or substantially similar to another gift sent to the recipient by another user.

Furthermore, Block S130 can select multiple gift items to be advertised to the sender in Block S140. For example, Block S130 can select three different items suitable as gifts for the recipient. The items can be of similar cost and function but be of different configurations or include different types or levels of personalization. The items can alternatively be of varying price in order to give the sender a substantially wide price window of available gifts. In this implementation, Block S130 can also rank the selected gifts, such as according to estimated interest of the recipient, estimated relevance to the sender, price, complementary correlation with a gift sent to the recipient by another user, perceived recipient need, or advertisement payments from manufacturers, suppliers, and/or retailers. However, Block S130 can select and rank any other number of gifts according to any other price, function, configuration, specification, personalization, etc.

Block S140 of the method S100 recites transmitting an electronic notification to the sender, the electronic notification including a recommendation for the gift for the recipient. Once Block S130 selects the gift for the recipient, Block S140 functions to entice the sender to purchase the gift through timely application of a targeted advertisement of the gift. Block S140 functions to advertise the gift to the sender through a notification, such as an app-based notification for a social networking ‘app’ executing on a mobile computing device used by the sender, such as shown in FIGS. 1, 2, and 3. Alternatively, Block S140 can deliver the notification as an email, SMS text message, voicemail, instant message, web browser pop-up, sidebar message within a sender interface of the social networking system, a calendar event, a Facebook message or wall post, a Twitter message, or any other suitable communication path, and the notification can be textual, visual, auditory, or of any other suitable type.

Block S140 can generate the notification that includes one portion identifying the recipient and the determined gift-appropriate event. This portion of the notification can therefore contextualize the gifting situation. For example, this portion of the notification can be in the form of short descriptive text, such as “It's Dan Harper's 24^{th} Birthday today,” or “Molly and Eric Johnson just had a baby.” Alternatively, the first portion can be a link to a Facebook page or a Twitter profile through which the sender can ascertain the nature of the event or situation. However, the first portion of the notification can be of any other form.

Block S140 can generate the notification that includes a second portion that is a recommendation for the selected gift. The recommendation can be in the form of an image, an animation, a video, and/or a text description. For example, the recommendation can include “Take Dan out for a beer with this discounted deal for drinks at this local bar,” or “Send this bouquet of flowers to Molly and Eric.” In another example, the recommendation can include an image of a cupcake and a caption that reads “Send Dan a cupcake for his birthday.”

Block S140 can generate the notification that further includes a third portion that directs the sender to a venue through which to purchase the gift for the recipient. For example, Block S140 can incorporate a link, within the notification, to an online merchant that offers the gift for sale. This third portion of the notification can be implemented by Block S160 of the method S100 to direct the sender to complete a gift order for the recipient, as described below. However, Block S140 can generate the notification that identifies the recipient, the determined gifting event, and the suggested gift in any other suitable way.

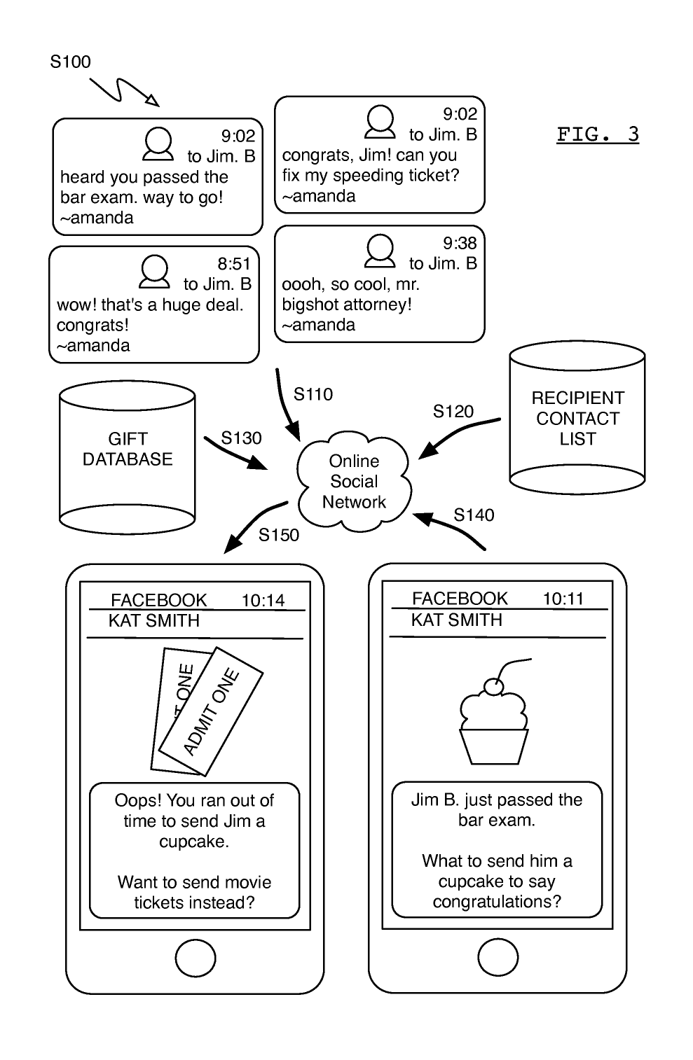

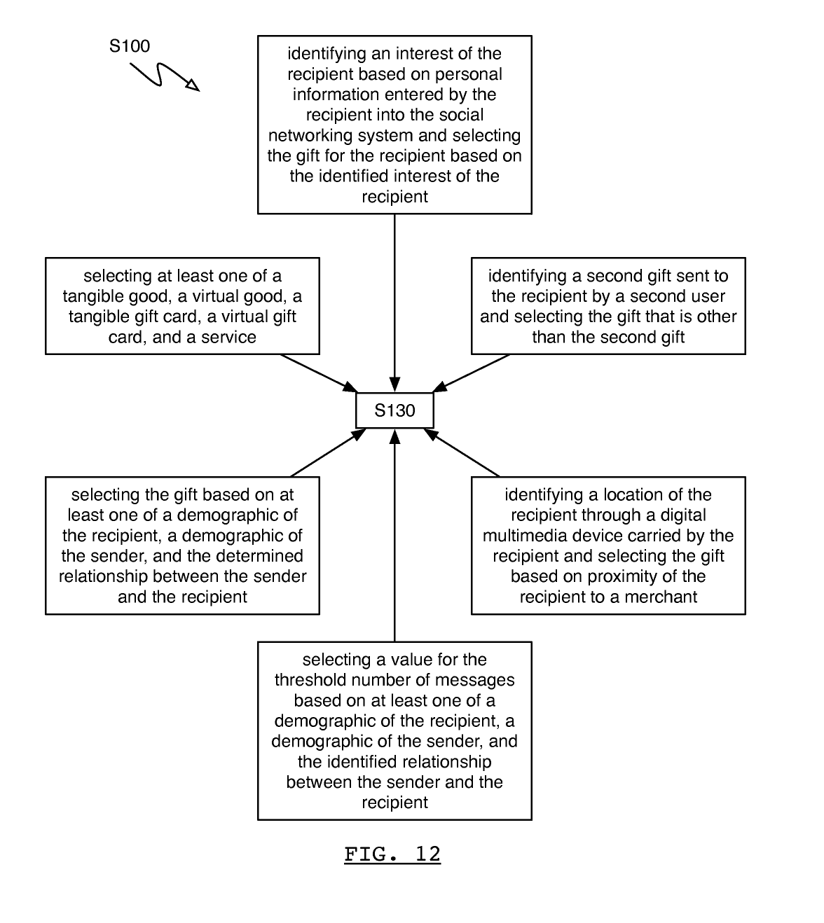

As shown in FIGS. 9 and 13, Block S150 of the method S100 recites modifying the recommendation in response to an update event following transmission of the electronic notification to the sender and prior to purchase of the gift, by the sender, for the recipient. Generally, Block S150 enables a dynamic gift advertisement. In one example implementation and as shown in FIGS. 3 and 11, Block S150 can modify the notification by exchanging the recommendation for the gift for a second recommendation for a second gift in response to expiration of a specified period of time following communication of the notification to the sender and prior to purchase of the gift, for the recipient, by the sender. In this example implementation, Block S150 can select the specified period of time according to at least one of a demographic of the recipient, a demographic of the sender, and a quality of the gift. Therefore, in at least one implementation, Block S150 can incorporate a time component into the gift advertisement. For example, Block S150 can warn the sender that the proposed gift will be reserved for the sender for ten minutes, at which point, if not purchased by the sender, the gift will be retracted and made available to another potential sender.

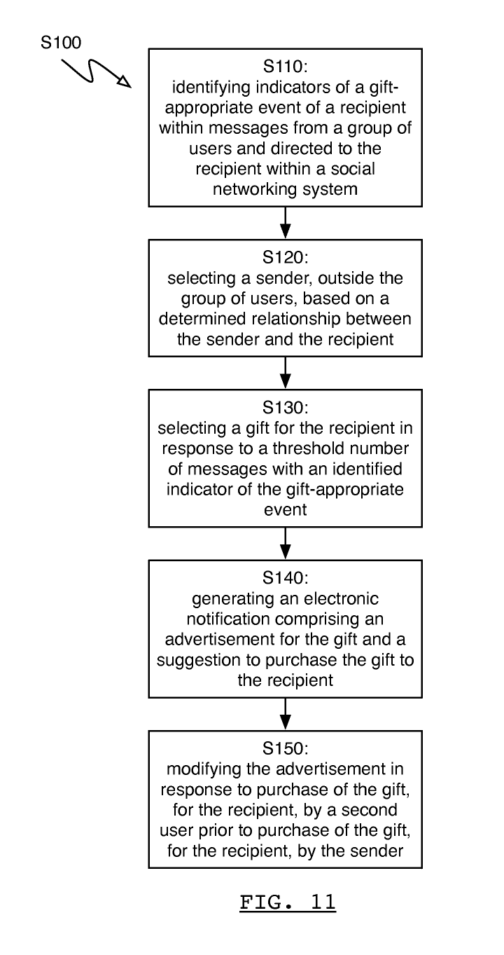

In another example implementation shown in FIG. 1, Block S150 can modify the notification by exchanging the recommendation for the gift for a second recommendation for a second gift in response to purchase of the gift, for the recipient, by a second user prior to purchase of the gift, for the recipient, by the sender. In this example implementation, Block S150 can track gift purchases, for the recipient, by additional senders and compare these to the selected gift to identify duplicates, as described in U.S. application Ser. No. 13/615,289, which is incorporated herein by reference. In a similar example implementation and as shown in FIGS. 2 and 10, Block S150 can modify the notification by exchanging the recommendation for the gift for a second recommendation for a second gift in response to a status change entered into the social networking system by the recipient. In this example implementation, Block S150 can track and analyze data entered by the recipient (and sender and other users) into the social networking system to identify recipient (or other) status changes that may affect gifting, gifting parameters, or the appropriateness of gifting for the event.

In another example implementation, the method S100 can advertise the same particular gift to multiple senders, and, once one sender purchases the particular gift for the recipient, Block S150 can modify the remaining advertisements to include an alternative gift item, which can reduce the likelihood of duplicate gifts being purchased for the same recipient. Similarly, Block S150 can cycle through a set of gifts selected for the recipient in Block S130 and update the recommendation within the notification accordingly, such as every thirty seconds.

Block S150 can additionally or alternatively modify parameters of the selected gift. In one example implementation, Block S150 can modify the notification by modifying an advertised price of the gift. For example, Block S150 can increase the price of the gift by 5% every minute that the sender does not complete an order for the gift following communication of the notification to the sender. Block S150 can alternatively adjust a shipping price for the gift, available gift configurations, gift personalization, etc., such as based on passage time following communication of the notification to the sender. However, Block S150 can modify the recommendation in any other way and according to any other parameter, event, gift selection, sender input, recipient input, user input, etc. of Block S140, etc.

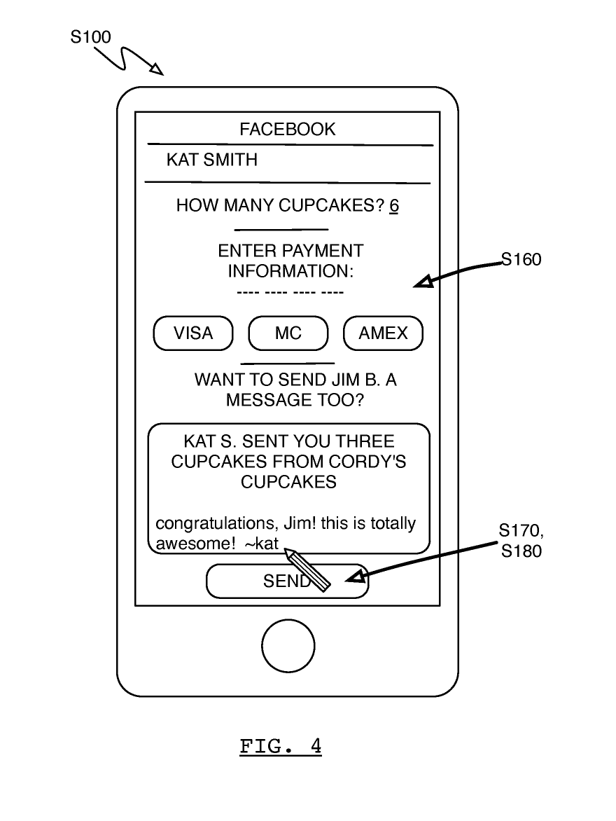

As shown in FIG. 4, one variation of the method S100 further includes Block S160, which recites directing the sender to purchase the gift for the recipient. Generally, Block S160 enables a path through which the sender may compete a gift order for the gift. The path can be accessible to the sender through the notification or within the recommendation such that minimal redirection or sender action is required to initiate the gift order. In one implementation, Block S160 enables the sender to click, swipe, type or enter information, or otherwise interact with the notification directly to complete an order for the gift. Alternatively, Block S160 can incorporate a link or pointer to a separate vendor, website, application, service, etc. through which the sender can purchase the gift for the recipient. For example, Block S160 can incorporate a “purchase” field within the notification and captures a gift order based on an input into the purchase field. Alternatively, in response to sender selection of the recommendation, Block S160 can automatically direct the sender to a retail venue or other online merchant (e.g., via a hyperlink) through which the sender can enter payment information, recipient delivery information, and/or other necessary gift delivery information. Block S160 can similarly open a popup window configured to receive a sender gift order following sender selection of the recommendation or a hyperlink within the notification. However, Block S160 can implement any other suitable method or technique to enable the sender to purchase the gift.

Block S160 can also auto-fill some or all of required order information, such as credit card, debit card, banking, or other payment information of the sender, recipient delivery address, delivery method, sender and/or recipient shipping preferences, recipient name, and/or sender name. Block S160 can access this information by mining appropriate information from a social network profile of the sender and/or recipient and/or by accessing gifting or online shopping information previously entered by the sender and/or recipient. For example, Block S160 can access the sender's social networking account that maintains the sender's virtual currency or virtual points (e.g., Facebook points) account or that stores sender checking, debit card, and/or credit card information. Block S160 can similarly access a billing address of the sender and can access a delivery address of the recipient. In one example, for the gift that is a virtual product, Block S160 can set the recipient's social network profile as the destination of the gift. In another example, for the gift that is a tangible product, Block S160 can mine a street address of the recipient from his social network profile, such as according to privacy settings set by the recipient. In yet another example, for the gift that is redeemable coupon for an experience, Block S160 can set an email address linked to the recipient's social networking system ing profile as the destination of the coupon. Alternatively, Block S160 can prompt the sender to enter any one or more of billing information, billing address, delivery information, shipping options, etc., such as in the event that certain sender or recipient information is not available through the social networking system, as shown in FIG. 4. Block S160 can also delay sender entry of payment information until the gift is confirmed or accepted by the recipient, such as described in U.S. application Ser. No. 13/615,289, which is incorporated in its entirety by this reference.

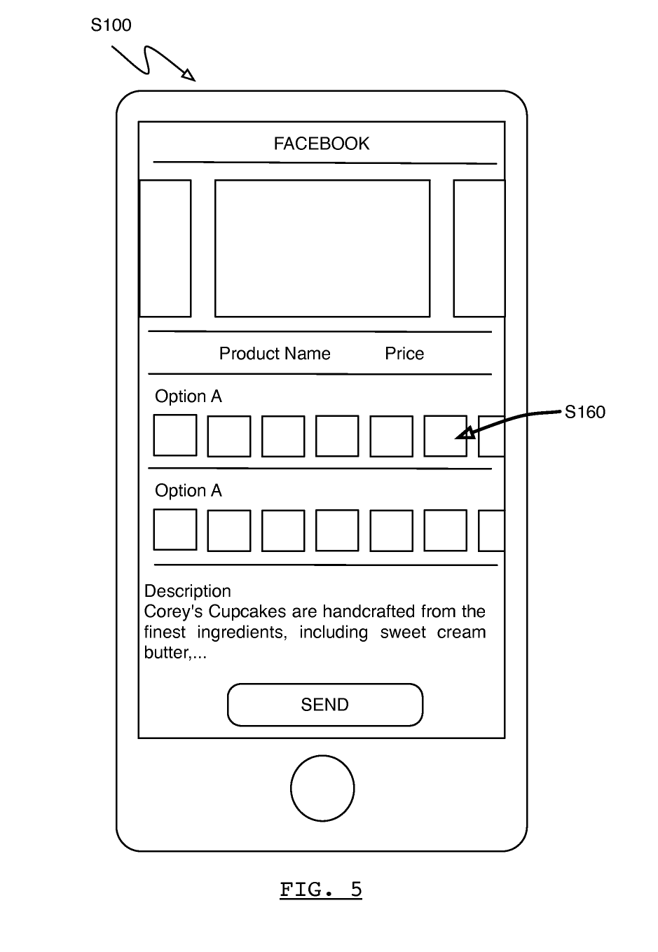

Block S160 can also prompt the sender to customize the gift, such as shown in FIG. 5 and described in U.S. application Ser. No. 13/615,289. For example, Block S160 can prompt the sender to select a color, size, configuration, form, engraving, etc. for the gift while the sender is completing the gift order. Block S160 can also prompt the sender to complete a card, made out to the user, to accompany the gift when delivered to the recipient. However, Block S160 can function in any other way to direct the sender to purchase the gift for the recipient.

As shown in FIG. 4, one variation of the method S100 further includes Block S170, which recites initiating delivery of the gift to the recipient. In one example, for the gift that is a virtual product, Block S170 delivers the gift to the recipient's social network profile. In another example, for the gift that is a tangible product, Block S170 transmits gift order details, such as item SKU number, quantity, payment information, and destination, to an order fulfillment service (e.g., Amazon.com), wherein the order fulfillment service fulfills the order by shipping the gift to the recipient. In yet another example, for the gift that is a redeemable coupon for an experience, Block S170 delivers the coupon to an email address linked to the recipient's social network profile. However, Block S170 can function in any other way to initiate delivery of the gift to the recipient.

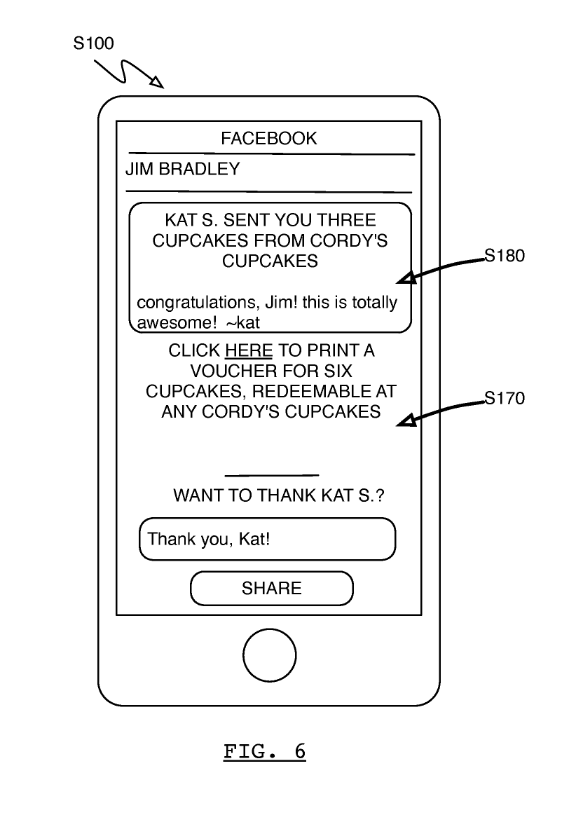

As shown in FIG. 6, one variation of the method S100 includes Block S180, which recites transmitting a note to the recipient from within the social networking system. In one example, Block S160 prompts the sender to draft a note to the recipient while completing an order for the gift, and once the sender completes the gift order and selects a “Send” button to confirm the gift, Block S180 delivers the note, through the social networking system, to the recipient's social network profile. In another example, once the sender selects the gift, completes the note, and selects a “Send” button, Block S180 delivers the note, through the social networking system, to the recipient's social network profile, wherein communication of the note completes the gift order and triggers delivery of the gift to the recipient in Block S170. Block S180 can also attach a notification of the gift order to the note such that the recipient can review the gift with the sender's note. Alternatively, such as in the implementation in which the gift is a virtual product, Block S180 can cooperate with Block S170 to bundle the gift with the note and to deliver the note and gift set to the recipient. Block S180 can alternatively transmit the note, from the sender, to the recipient via any other suitable communication path, such as email, SMS text message, notification on a mobile computing device, postal letter, etc. However, Block S180 can function in any other way to transmit a note from the sender to the recipient.

In one variation, the method S100 implements one or more of the foregoing techniques and/or functionalities to determine an upcoming event of the recipient, to select a gift, and to notify a sender of the upcoming event such that the sender can provide a gift to the recipient on time for the event. For example, the method S100 can determine that the user is schedule to take a standardized test on the following Saturday, such as by accessing a calendar of the recipient or by analyzing a post by the recipient within the social networking system and identifying a cue of an upcoming event. Based on this extracted information suggestive of the upcoming event, the method can select a recommended gift for the recipient, incorporate a recommendation for the gift into a notification, and deliver the notification to the sender prior to the event. However, the method S100 can function in any other way to achieve any other suitable functionality pertaining to recommending a gift to a sender prior to a gift-appropriate event, during a gift-appropriate event, and/or succeeding a gift-appropriate event.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
within a set of communications from a set of users of a social networking system and directed to a recipient from within the social networking system, identifying indicators of a gift-appropriate event of the recipient;
selecting a sender, outside the set of users, based on a determined relationship between the sender and the recipient;
selecting a gift for the recipient in response to a threshold number of communications with an identified indicator of the gift-appropriate event;
transmitting an electronic notification to the sender, the electronic notification comprising a recommendation for the selected gift for the recipient; and
modifying the recommendation in response to an update event following transmission of the electronic notification to the sender and prior to purchase of the gift, by the sender, for the recipient.

2. The method of claim 1, wherein identifying indicators of the gift-appropriate event of the recipient comprises implementing natural language processing to identify indicators of the gift-appropriate event within the set of communications.

3. The method of claim 1, wherein selecting the gift for the recipient comprises identifying an interest of the recipient based on personal information entered by the recipient into the social networking system and selecting the gift for the recipient based on the identified interest of the recipient.

4. The method of claim 1, wherein selecting the gift for the recipient comprises identifying a second gift sent to the recipient by a second user and selecting the gift that is other than the second gift.

5. The method of claim 1, wherein selecting the gift for the recipient comprises selecting the gift based on at least one of a demographic of the recipient, a demographic of the sender, and the determined relationship between the sender and the recipient.

6. The method of claim 1, wherein selecting the gift for the recipient comprises identifying a location of the recipient through a digital multimedia device carried by the recipient and selecting the gift based on proximity of the recipient to a merchant.

7. The method of claim 1, wherein selecting the gift for the recipient comprises selecting at least one of a tangible product, a virtual product, a tangible gift card, a virtual gift card, and a service.

8. The method of claim 1, wherein selecting the gift for the recipient comprises selecting a value for the threshold number of communications based on at least one of a demographic of the recipient, a demographic of the sender, and the identified relationship between the sender and the recipient.

9. The method of claim 1, wherein selecting the sender comprises determining a relationship status between the sender and the recipient, the relationship status stored in the social networking system.

10. The method of claim 1, wherein selecting the sender comprises selecting the sender based on a lack of communication between the sender and the recipient, within the social networking system, on a date coinciding with the identified gift-appropriate event.

11. The method of claim 1, wherein transmitting the electronic notification comprises transmitting the electronic notification that further comprises a link to an online merchant offering the gift for sale.

12. The method of claim 1, wherein modifying the recommendation comprises exchanging the recommendation for the gift for a second recommendation for a second gift in response to purchase of the gift, for the recipient, by a second user prior to purchase of the gift, for the recipient, by the sender.

13. The method of claim 1, wherein modifying the recommendation comprises exchanging the recommendation for the gift for a second recommendation for a second gift in response to expiration of a specified period of time following communication of the notification to the sender and prior to purchase of the gift, for the recipient, by the sender.

14. The method of claim 1, wherein modifying the recommendation comprises exchanging the recommendation for the gift for a second recommendation for a second gift in response to a status change entered into the social networking system by the recipient.

15. A method comprising:
identifying indicators of a gift-appropriate event of a recipient within a set of communications from a set of users and directed to the recipient within a social networking system;
selecting a sender, outside the set of users, based on a determined relationship between the sender and the recipient;
selecting a gift for the recipient in response to a threshold number of communications with an identified indicator of the gift-appropriate event;
generating an electronic notification comprising a recommendation for the selected gift for the recipient; and
modifying the recommendation in response to expiration of a specified period of time following communication of the notification to the sender and prior to purchase of the gift by the sender for the recipient.

16. The method of claim 15, wherein modifying the recommendation in response to expiration of a specified period of time comprises selecting the specified period of time according to at least one of a demographic of the recipient, a demographic of the sender, and a quality of the gift.

17. The method of claim 15, wherein modifying the recommendation comprises exchanging the recommendation for the gift for a second recommendation for a second gift.

18. The method of claim 15, wherein modifying the recommendation comprises modifying an advertised price of the gift.

19. A method comprising:
identifying indicators of a gift-appropriate event of a recipient within a set of communications from a set of users and directed to the recipient within a social networking system;
selecting a sender, outside the set of users, based on a determined relationship between the sender and the recipient;
selecting a gift for the recipient in response to a threshold number of communications with an identified indicator of the gift-appropriate event;
generating an electronic notification comprising a recommendation for the gift and a suggestion to purchase the gift to the recipient; and
modifying the recommendation in response to purchase of the gift, for the recipient, by a second user prior to purchase of the gift, for the recipient, by the sender.

20. The method of claim 19, wherein modifying the recommendation comprises tracking gift purchases, for the recipient, by additional senders and comparing the selected gift to gift purchases by the additional senders.
